(19) United States
(12) Patent Application Publication
(10) Pub. No.: US 2006/0187841 A1
(43) Pub. Date: Aug. 24, 2006

(54) Methods, systems, and computer program products for suppressing congestion control at a signaling system 7 network node

(75) Inventor: Jonathan James Palmer, Durham, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/065,202

(22) Filed: Feb. 24, 2005

(51) Int. Cl. H04L 1/00

(52) U.S. Cl. 370/236

(57) ABSTRACT

Methods, systems, and computer program products for suppressing congestion control at an SS7 network node include determining whether a transfer controlled message triggering condition exists for at least one signaling link in a telecommunications network. In response to determining that a transfer controlled message triggering condition exists, the generation of transfer controlled messages are suppressed for a predetermined time period. A transfer controlled message triggering condition may include a changeover or changeback procedure, or a determination that there is congestion on the signaling link. Alternatively, or in addition, in response to determining that a transfer controlled message triggering condition exists, generation of a transfer controlled message may be suppressed based on a number of unacknowledged messages associated with the least one signaling link.

### TECHNICAL FIELD

The subject matter described herein relates to telecommunications network congestion control and more particularly to suppressing congestion control in a telecommunications network.

### BACKGROUND

Signaling system 7 (SS7) is the standard signaling protocol that has been used to control voice calls in public telephone networks since the late 1980's. In addition to the control of voice calls, SS7 signaling enables modern telephony services, such as toll-free calling, call forwarding, caller ID, local number portability (LNP), and even mobile communications services. SS7 network nodes used in setting up calls and providing additional services include service switching points (SSPs), signal transfer points (STPs), and service control points (SCPs). SSPs perform call setup signaling and control voice trunks over which calls are carried. STPs route SS7 messages between other network nodes. SCPs provide database services to SSPs.

FIG. 1 illustrates a conventional SS7 network. In FIG. 1, the SS7 network includes STPs 100, 102, 104, and 106, SSPs 108 and 110, and SCP 112. STPs 100, 102, 104, and 106 are interconnected by linksets LS1-LS6. Each linkset includes a plurality of channels, which are referred to as signaling links. Each pair of nodes is connected by a single linkset. Messages are distributed among links in a linkset using load balancing algorithms. STPs 100, 102, 104, and 106 maintain routing tables that contain signaling routes corresponding to linksets. In SS7 networks, signaling messages are routed based on destination point code (DPC) values. When a signal transfer point receives a message, it examines the destination point code of the message and selects a route from the routing table. The route corresponds to a linkset. The signal transfer point then selects a link within the linkset and forwards the message over the link. STPs 100, 102, 104, and 106 also maintain status information associated with SS7 signaling routes. For example, if a signaling route becomes unavailable, the signal transfer point preferably detects this fact and marks the route unavailable in its route tables. Similarly, if a route becomes congested, the signal transfer point marks the route as congested in its route table.

In an SS7 network, the above-described route status management functionality is accomplished, in part, through the use of specific network management messages. A sample structure of an SS7 message signaling unit (MSU) 200 that carries network management information is illustrated in FIG. 2. It will be appreciated by those skilled in the art of SS7 signaling communications that signaling information field (SIF) 202 of MSU 200 can contain data associated with a particular point code that is experiencing difficulty or a particular link that has failed. Additional status information, priority codes, and other relevant maintenance codes may also be included in SIF parameter 202, depending upon the particular type of network management message being sent.

Returning to FIG. 1, STP 100 may determine that congestion exists on the route corresponding to signaling linkset LS1 using any of a variety of methods for detecting congestion. For example, the number of messages waiting to be sent over a signaling link on the route may be counted to determine if a threshold that indicates congestion on the link is exceeded. If STP 100 determines there is congestion on a signaling link within LS1, when an MSU is received from SSP 108 at STP 100 for routing over that signaling link, STP 100 sends a transfer controlled message (TFC) with a congestion level indicator to SSP 108. The TFC is sent to the originating signaling point of the original message, indicating that the destination signaling point of the original message is congested at the congestion level of the signaling link.

When STP 100 has determined that a signaling link is in congestion, STP 100 will also determine if the signaling link should discard messages. For example, a signaling link may use a method similar to the congestion detection stated above, except that for discard it would use a higher threshold limit. A signaling link would have a discard level assigned based on the number of messages waiting to be sent over the link. The discard level indicator conveys the minimum priority level a message must possess before it will be routed over the congested signaling link. Priorities are assigned by the originating signaling point, in this case SSP 108. Only messages of the same or higher priority than indicated by the discard level indicator will be forwarded by STP 100 via congested route LS1, with messages of lower priority being discarded by STP 100.

A TFC message may be sent on a regular basis to update the originating signaling point of the congestion status. Two timers are maintained in the originating signaling point as part of the SS7 signaling route set congestion test (RCT) procedure to help determine whether the route is still congested. If no TFCs are received before a first timer (referred to as T15) expires, an RCT message is sent by SSP 108 with a priority level that is one less than the previously known congestion status priority level. If the route is still congested, STP 100 will send a new TFC message indicating the congestion level. If no new TFC message is received before a second timer (referred to as T16) expires, then the route is considered to still be congested but at one lower congestion level than the level indicated in the RCT message. The RCT message is sent again with the lower priority, and the procedure is repeated until the route is found to be at level 0 priority, which indicates there is no congestion.

The purpose of the TFC procedure described above is to prevent a congested route from becoming further congested. The originating signaling point code that receives a TFC should stop sending all traffic to the congested signaling point that has a lower priority than the congestion level. The decrease in messages should allow the network to process the high priority messages with minimal delay and also alleviate the congestion situation. With other nodes in the network, such as SSP 108 and STP 100, discarding low priority messages, the processor at the terminating end of the linkset can process and acknowledge the high priority messages and still reduce congestion.

Some congestion scenarios, however, are transient and abate without requiring any intervention in the form of traffic reduction/prioritizing. For example, the SS7 changeover and changeback procedures are prone to causing temporary congestion on a link because the procedures cause traffic to be buffered during the event and processed at higher than normal rates after the event in order to process the queued traffic in a minimal timeframe. The changeover procedure is used to divert traffic away from a failed link. In such a case, messages buffered for the failed link are placed in a buffer associated with an alternate link within the same linkset. The changeback procedure is used when the failed link has been restored and traffic may now resume over that link. In the changeback procedure, transmission of messages on the alternate link is stopped, and transmission over the restored link resumes. During these procedures, traffic that has been held, i.e., buffered for the respective link, is eventually released and must be transmitted very quickly so that additional newly incoming traffic can also be sent with little or no delay. The number of buffered messages is directly dependent on the traffic rate and the amount of time for changeover or changeback event to complete. While attempting to clear the on-hold buffer, the transmission rate over the link is higher than normal. This condition lasts until all held traffic is forwarded in order to free up resources for newly incoming traffic. This higher transmission rate may cause a temporary period of congestion. This congestion will normally abate relatively quickly, e.g., in less than one second, making the TFC procedure unnecessary to prevent further congestion. In such a case, however, the TFC procedure is conventionally invoked, according to the SS7 standards, such as the GR-246-CORE and Q.704 specifications. This invocation of the TFC procedure results in an unnecessary limitation of traffic flow within the network and will likely result in causing more discarding of messages and/or delayed sending of messages. The invocation of the TFC procedure may also result in congestion in other areas of the network if traffic is re-routed to alternate service nodes.

What are therefore needed are methods, systems, and computer program products for congestion control that include the selective suppression of TFC messages.

### SUMMARY

According to one aspect, the subject matter disclosed herein includes a method for suppressing congestion control at an SS7 network node that includes determining whether a transfer controlled message triggering condition exists for at least one signaling link in a telecommunications network. In response to determining that a transfer controlled message triggering condition exists, the generation of transfer controlled messages are suppressed for a predetermined time period.

In one example, determining whether a transfer controlled message triggering condition exists for at least one signaling link in the telecommunications network may include determining that a changeover or changeback procedure involving the at least one signaling link has occurred, or determining whether there is congestion on the at least one signaling link.

In another aspect of the subject matter disclosed herein, a method for suppressing congestion control at an SS7 network node includes determining whether a transfer controlled message triggering condition exists for at least one signaling link in a telecommunications network and, in response to determining that a transfer controlled message triggering condition exists, suppressing generation of a transfer controlled message based on a number of unacknowledged messages that were transmitted by the SS7 network node over the least one signaling link.

In another aspect of the subject matter disclosed herein, a system for suppressing congestion control at an SS7 network node includes logic configured to determine whether a transfer controlled message triggering condition exists for at least one signaling link in a telecommunications network and logic configured to, in response to determining that a transfer controlled message triggering condition exists, suppress generation of transfer controlled messages for a predetermined time period.

In another aspect of the subject matter disclosed herein, a system for suppressing congestion control at an SS7 network node includes logic configured to determine whether a transfer controlled message triggering condition exists for at least one signaling link in a telecommunications network; and logic configured to, in response to determining that a transfer controlled message triggering condition exists, suppress generation of a transfer controlled message based on a number of unacknowledged messages that were transmitted by the SS7 network node over the least one signaling link.

In another aspect of the subject matter disclosed herein, a computer program product comprising computer executable instructions embodied in a computer-readable medium for performing steps at an SS7 network node in a telecommunications network that include determining whether a transfer controlled message triggering condition exists for at least one signaling link and, in response to determining that a transfer controlled message triggering condition exists, suppressing generation of transfer controlled messages for a predetermined time period.

In another aspect of the subject matter disclosed herein, a computer program product comprising computer executable instructions embodied in a computer-readable medium for performing steps at an SS7 network node in a telecommunications network includes determining whether a transfer controlled message triggering condition exists for at least one signaling link and, in response to determining that a transfer controlled message triggering condition exists, suppressing generation of transfer controlled messages for a predetermined time period.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a conventional SS7 network;

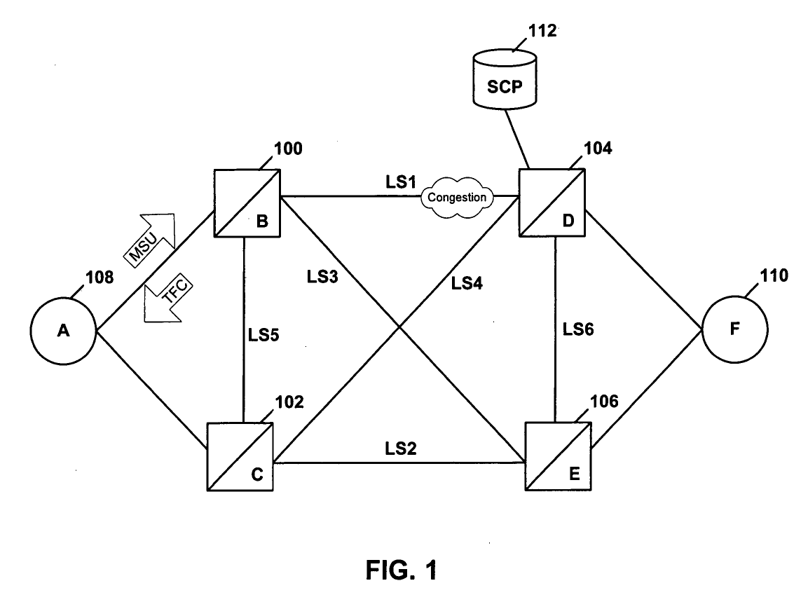

FIG. 2 is a block diagram illustrating a sample structure of a typical SS7 message signaling unit that carries MTP level 3 network management information;

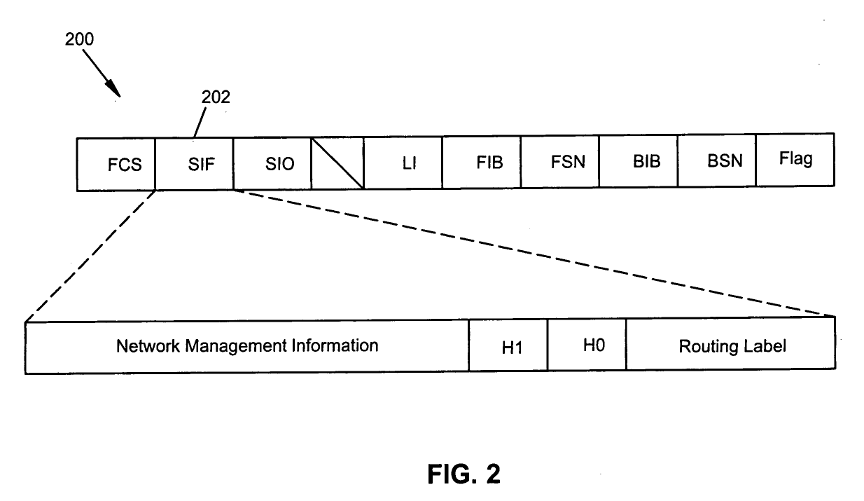

FIG. 3 is a block diagram illustrating a communications scenario in which systems and methods for suppressing congestion control at an SS7 network node may be implemented, according to an aspect of the subject matter disclosed herein;

FIG. 4 is a flow diagram illustrating a method for suppressing congestion control at an SS7 network node according to an aspect of the subject matter disclosed herein;

FIG. 5 is a flow diagram illustrating an exemplary implementation of a method for suppressing congestion control at an SS7 network node according to an aspect of the subject matter disclosed herein;

FIG. 6 is a flow diagram illustrating a method for suppressing congestion control at an SS7 network node according to another aspect of the subject matter disclosed herein; and

FIG. 7 is a flow diagram illustrating a method for suppressing congestion control at an SS7 network node according to yet another aspect of the subject matter disclosed herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed. Any such form of embodiment can be referred to herein as “logic configured to” perform a described action, or alternatively as “logic that” performs a described action.

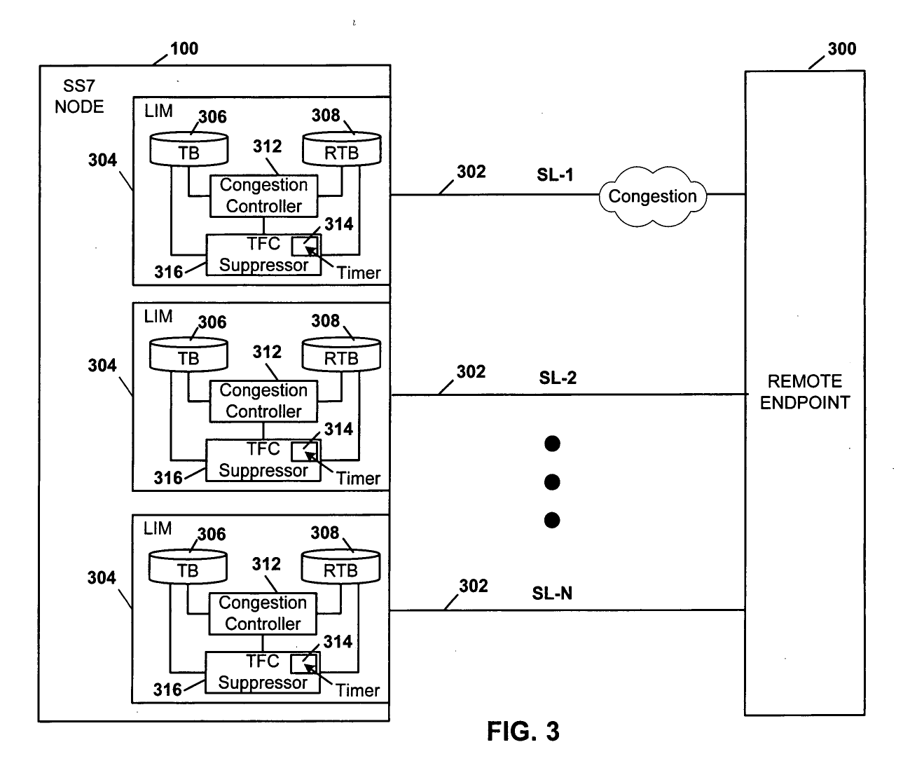

FIG. 3 is a block diagram illustrating a communications scenario in which systems and methods for suppressing congestion control at an SS7 network node may be implemented, according to an aspect of the subject matter disclosed herein. In FIG. 3, an exemplary SS7 network includes STP 100 connected to a remote endpoint 300 by a plurality of signaling links 302, namely SL-1 to SL-N. STP 100 may include functionality for suppressing TFC message generation, as will be described in detail below. Although STP 100 is shown by way of example, it is understood that the TFC suppression methods described herein may be implemented in any suitable network node that implements SS7 congestion control procedures. Signaling links 302 may be part of the same signaling linkset or may belong to a combined linkset. STP 100 may include one or more link interface modules (LIMs) 304 that send and receive signaling messages over signaling links 302. From a hardware perspective, each LIM 304 may include a printed circuit board with an application processor, a communications processor, memory, and one or more ports for signaling links. From a software perspective, each LIM may implement message transfer part layers 1-3, including TFC generation, changeover, and changeback procedures. In order to implement changeover and changeback procedures, each LIM 304 may include a transmit buffer 306 and a retransmit buffer 308. Buffers 306 and 308 may be implemented on a per link basis. Each LIM 304 may also include a congestion controller 312 for generating TFC messages based on predetermined triggering events, such as congestion on a signaling link. A timer 314 and a TFC suppressor 316 may suppress generation of TFCs when the congestion is transient in nature or during other user-specified conditions.

As indicated in FIG. 3, a signaling link 302 such as SL-1 may experience congestion. The congestion status of a signaling link 302 may be determined, for example, by the sum of MSUs in the transmit buffer 306 and retransmit buffer 308 associated with signaling link 302. Transmit buffer 306 stores MSUs waiting to be transmitted on signaling link 302. Once an MSU is transmitted on signaling link 302, a copy of the transmitted MSU is placed in retransmit buffer 308 until an acknowledgment message is received indicating that the MSU has been received by the remote endpoint 300, at which time the copy of the MSU may be discarded. When one of the signaling links 302 experiences congestion, MSUs waiting to be transmitted collect in transmit buffer 306. Similarly, MSUs that have been transmitted that have not been acknowledged collect in retransmit buffer 308. The number of MSUs in the combination of these two buffers may be used to provide an indication of congestion on the signaling link 302. For example, a threshold number of MSUs may be used for comparison. The number of MSUs in transmit buffer 306 and retransmit buffer 308 may be monitored by congestion controller 312 and TFC suppressor 316. Here, it should be pointed out that congestion on signaling link 302 may be caused by problems at remote endpoint 300 in receiving, processing, and/or acknowledging MSUs, in addition to any of a number of other causes. As discussed above, when congestion is indicated on signaling link 302, the TFC procedure described above would normally be invoked. Accordingly, a congestion determination for a signaling link may be considered as one of a number of TFC triggering conditions for the present purposes.

When one of signaling links 302 fails, a changeover procedure is initiated to move MSUs from the failed signaling link to an alternate signaling link. Initially, all traffic over the failed signaling link is halted. The associated LIM 304 begins exchanging MSU sequence information via an alternate signaling link with remote endpoint 300 to ensure that packets are sequenced properly at remote endpoint 300. During this exchange of sequence information, MSUs continue to be received and stored in transmit buffer 306. Once the sequencing procedure is completed, MSUs are moved from the failed signaling link to one or more alternate signaling links. Preferably, the MSUs in retransmit buffer 308 are transmitted over the alternate signaling link first, since those MSUs were received first in time. After that, MSUs from transmit buffer 306 are transmitted over the alternate signaling link. Once again, at this point a relatively large number of MSUs may have collected in transmit buffer 306 of the failed link while the sequencing operation was taking place. As a result, a large number of MSUs are added to the alternate signaling link. In order to handle the added traffic, LIM 304 for the alternate signaling link must quickly transmit the MSUs from the transmit and retransmit buffers of the failed link over the alternate signaling link so that the LIM can continue processing newly received MSUs to be sent over the alternate link in a timely manner.

Depending on the number of MSUs that were stored in the transmit buffer, retransmit buffer, and the on-hold queue, the alternate link may experience congestion. Moreover, the congestion will more than likely be relatively temporary, because the source of the congestion is the temporary high rate of traffic due to re-routing buffered messages, not the normal rate of traffic.

It therefore follows that a changeover could result in congestion on the alternate link, which would normally invoke the TFC procedure. Accordingly, a changeover may be considered to be another TFC triggering condition for the present purposes.

When the failed signaling link is restored, a changeback procedure is initiated to move MSUs from the alternate signaling link to the restored signaling link. Once again, the associated LIM 304 begins exchanging MSU sequence information with remote endpoint 300 to ensure that packets are sequenced properly at remote endpoint 300. A similar procedure to that of changeover is followed during changeback, which may result in a large number of MSUs being moved to the restored signaling link, which therefore may experience congestion temporarily as a result. Accordingly, a changeback results in congestion on the restored link, which would normally invoke the TFC procedure. Thus, a changeback procedure may be considered as yet another TFC triggering condition for the present purposes.

Both changeover and changeback are examples of events or conditions that result in temporary congestion on a signaling link. As can be appreciated by one of ordinary skill in this art, a number of other scenarios may cause congestion on a signaling link. In any case, SS7 specifications call for the initiation of the TFC procedure immediately when congestion is detected on a signaling link. As discussed above, many signaling link congestion scenarios result in temporary congestion on the signaling link that would otherwise abate without intervention but instead are compounded by the invocation of the TFC procedure, which in such a case causes unnecessary message discarding and/or rerouting in the network. According to an aspect of the subject matter described herein, additional precautions are taken to prevent the unnecessary invocation of the TFC procedure and the resulting worsening of what might otherwise be a relatively brief period of congestion. For example, when a TFC triggering condition exists, the generation of TFCs may be suppressed for a predetermined time period. Alternatively, or in addition, the number of MSUs in retransmit buffer 308 of LIM 304 for the associated signaling link 302 may be checked to confirm that there is a more sustained congestion, as opposed to a temporary congestion situation.

Returning to FIG. 3, according to one embodiment, a system for suppressing congestion control at an SS7 network node may include logic configured to determine whether a TFC triggering condition exists for at least one signaling link. For example, TFC suppressor 316 may detect congestion on an associated signaling link 302 according to a number of MSUs stored in the combination of transmit buffer 306 and retransmit buffer 308. Alternatively, TFC suppressor 316 may determine that a TFC triggering condition exists based on the initiation of a changeover to an alternate signaling link or a changeback to a restored signaling link. The system may also include logic configured to, in response to determining that a TFC triggering condition exists, suppress generation of TFCs for a predetermined time period. For example, TFC suppressor 316 and timer 314 may be employed to provide a delay period during which the generation of TFCs is suppressed.

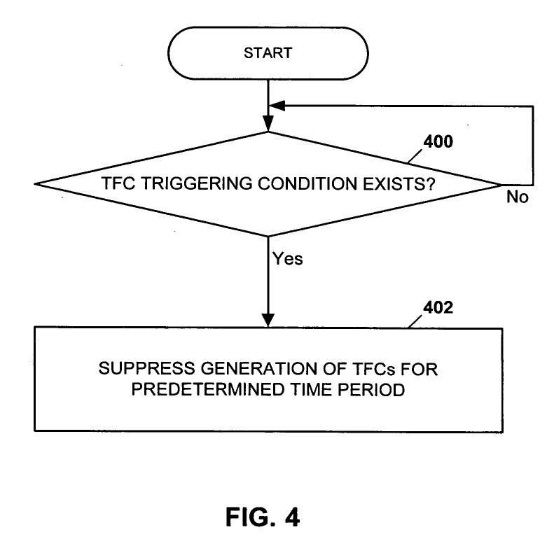

FIG. 4 is a flow diagram illustrating exemplary overall steps for suppressing congestion control at an SS7 network node according to an aspect of the subject matter disclosed herein. The steps may be implemented by TFC suppressor 316 and timer 314 illustrated in FIG. 3. In step 400, it is determined whether a TFC triggering condition exists. For example, determining whether a transfer controlled message triggering condition exists may include determining that a changeover procedure is initiated, that a changeback procedure is initiated, or that there is congestion on the associated signaling link. If it is determined that a TFC triggering condition exists in step 400, the generation of TFCs is suppressed for a predetermined time period in step 402.

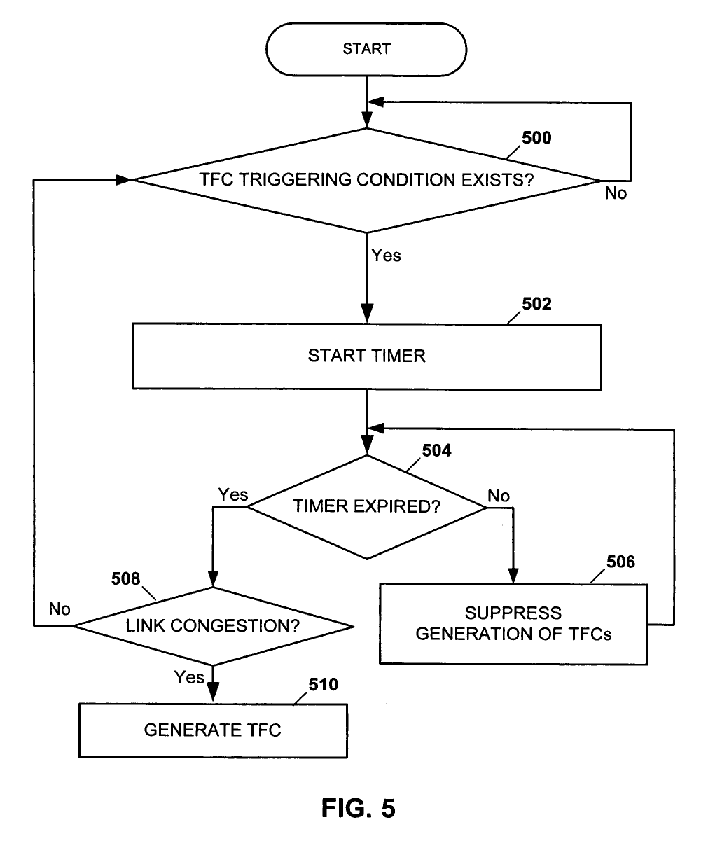

FIG. 5 is a flow diagram illustrating an exemplary implementation of a method for suppressing congestion control at an SS7 network node according to an aspect of the subject matter disclosed herein. The steps may be implemented by TFC suppressor 316 and timer 314 illustrated in FIG. 3. Referring to FIG. 5, in step 500 it is determined whether a TFC triggering condition exists. In response to determining that a TFC triggering condition exists in step 500, timer 314 is started in step 502, and it is determined in step 504 whether timer 314 has expired. In response to determining that timer 314 has not expired in step 504, the generation of TFCs is suppressed in step 506 and control returns to step 504 in a looped arrangement until timer 314 expires. In response to determining that timer 314 has expired in step 504, a check is made to determine if the associated signaling link is congested in step 508. If the link is still congested, the congestion is deemed not to be temporary and a TFC is generated in step 510. Alternatively, if the associated signaling link is determined not to be congested in step 508, control returns to step 500 and the unnecessary invocation of the TFC procedure has been avoided.

Timer 314 may be set to a predetermined time duration, which can be adjustable. In addition, timer 314 may include multiple time durations that are selectable by TFC triggering condition type. For example, when the TFC triggering condition results from a changeover being initiated, timer 314 may be set at a time duration of, for example, 2.5 seconds. This will allow enough time for the exchange of sequence information and transfer of MSUs (the exchange of sequence numbers may fail and a default timer of 1.4 seconds will terminate the procedure), some additional time for the resulting temporary congestion to build, and some additional time (about 0.5 seconds) for the congestion to abate on its own. When the TFC triggering condition desired to be suppressed results from a changeback being initiated, timer 314 may be set at a different time duration of, for example, 2.7 seconds. This will allow enough time for the exchange of changeback declarations and acknowledgements and transfer of MSUs (which may take 1.6 seconds if message exchange fails and default timers are required to terminate the procedure), some additional time for the resulting temporary congestion to build, and some additional time (about 0.5 seconds) for the congestion to abate on its own. When the TFC triggering condition desired to be suppressed results from congestion, timer 314 may be set to a time duration of approximately 1 second, since temporary congestion will typically abate in less than one second. The above-mentioned time durations are exemplary and other time durations may be used for those and other TFC triggering conditions, as can be appreciated.

According to another aspect of the subject matter disclosed herein, TFC suppressor 316 may confirm that congestion exists based on a determination of the number of MSUs currently stored in retransmit buffer 308. That is, based on the number of MSUs transmitted to remote endpoint 308 and not yet acknowledged, congestion on the signaling link may be confirmed. If the number of MSUs currently stored in retransmit buffer 308 does not exceed a predetermined threshold value, the congestion is deemed temporary and TFCs are suppressed. This follows from the fact that the impact of congestion on retransmit buffer 308 lags behind the impact on transmit buffer 306, and that for temporary congestion scenarios, retransmit buffer 308 is impacted less. During sustained congestion scenarios at the remote endpoint, however, MSUs will accumulate in retransmit buffer 308 waiting for acknowledgment. Accordingly, a system for suppressing congestion control at an SS7 network node can include logic configured to determine whether a TFC triggering condition exists for at least one signaling link and logic configured to, in response to determining that a TFC message triggering condition exists, suppress generation of a transfer controlled message based on a number of unacknowledged messages associated with the least one signaling link.

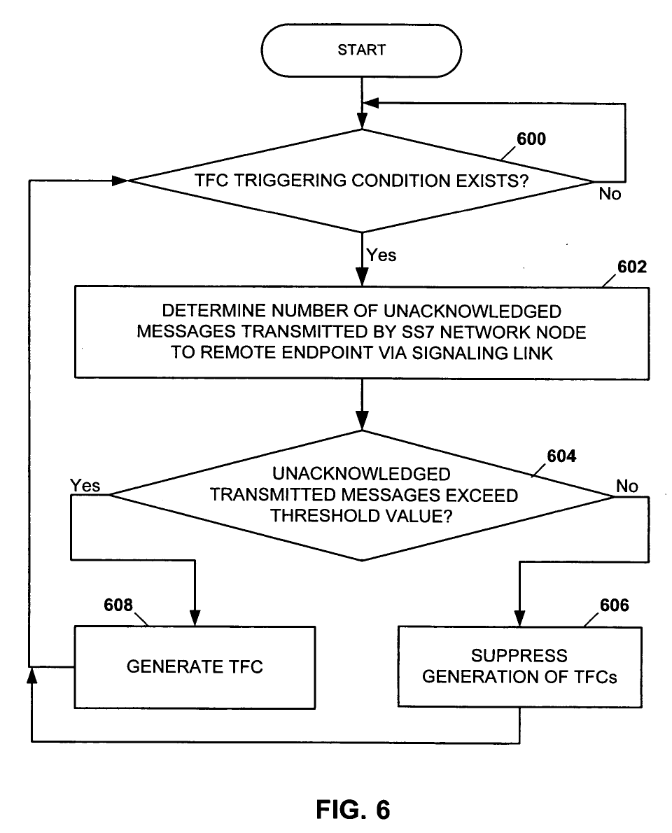

FIG. 6 is a flow diagram illustrating a method for suppressing congestion control at an SS7 network node according to another aspect of the subject matter disclosed herein. The steps illustrated in FIG. 6 may be implemented by TFC suppressor 316 and timer 314 illustrated in FIG. 3. In step 600, it is determined whether a TFC triggering condition exists. In response to determining that a TFCs triggering condition exists in step 600, generation of a TFC is suppressed based on a number of unacknowledged messages associated with the least one signaling link. For example, in step 602, a number of messages transmitted by the SS7 network node to a remote endpoint that have not been acknowledged by the remote endpoint are determined. This number may be determined, for example, by TFC suppressor 316 monitoring retransmit buffer 308. It is determined whether the number of unacknowledged transmitted messages exceeds a threshold value in step 604. In response to a determination in step 604 that the number of unacknowledged transmitted messages does not exceed the threshold value, the generation of TFCs is suppressed in step 606. In response to a determination in step 604 that the number of unacknowledged transmitted messages does exceed the threshold value, a TFC is generated in step 608. In either case, control returns to step 600.

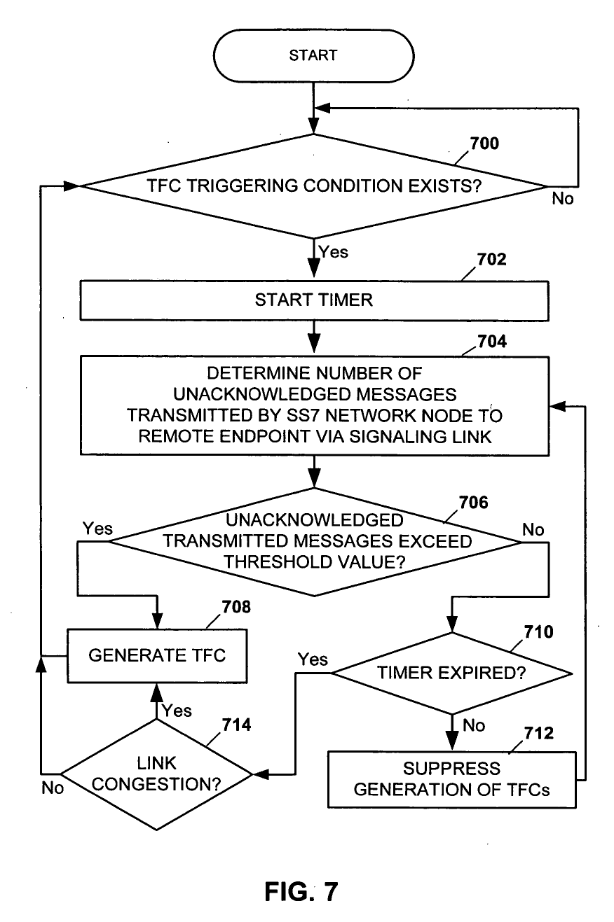

According to another implementation, the number of unacknowledged transmitted messages may be used in conjunction with the timed suppression of TFCs to confirm that congestion is temporary. FIG. 7 is a flow diagram illustrating a method for suppressing congestion control at an SS7 network node according to yet another aspect of the subject matter disclosed herein. The steps may be implemented by TFC suppressor 316 and timer 314 illustrated in FIG. 3. In step 700, it is determined whether a TFC triggering condition exists. In response to determining that a TFCs triggering condition exists in step 700, timer 314 is started in step 702. The number of unacknowledged messages transmitted by the SS7 network node to a remote endpoint via the associated signaling link is determined in step 704. In step 706, it is determined whether the number of unacknowledged transmitted messages exceeds a threshold value. In response to a determination in step 706 that the number of unacknowledged transmitted messages exceeds the threshold value, a TFC is generated in step 708 and control returns to step 700. In response to a determination in step 706 that the number of unacknowledged transmitted messages does not exceed the threshold value, it is determined whether timer 314 has expired in step 710. If timer 314 is determined not to have expired in step 710, the generation of TFCs is suppressed in step 712 and control returns to step 704. If timer 314 is determined to have expired in step 710, a check is made to determine if the associated signaling link is congested in step 714. If the signaling link is still congested, the congestion is deemed not to be temporary and a TFC is generated in step 708. Alternatively, if the associated signaling link is determined not to be congested in step 714, control returns to step 700 and the unnecessary invocation of the TFC procedure has been avoided.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for suppressing congestion control, the method comprising:
at a signaling system 7 (SS7) network node:
(a) determining whether a transfer controlled (TFC) message triggering condition exists for at least one signaling link in a telecommunications network; and
(b) in response to determining that a transfer controlled message triggering condition exists, suppressing generation of transfer controlled messages for a predetermined time period.

2. The method of claim 1 wherein the SS7 network node comprises a signaling transfer point (STP).

3. The method of claim 1 wherein determining whether a transfer controlled message triggering condition exists for at least one signaling link in the telecommunications network comprises determining whether a changeover procedure involving the at least one signaling link has occurred.

4. The method of claim 1 wherein determining whether a transfer controlled message triggering condition exists for at least one signaling link in the telecommunications network comprises determining whether a changeback procedure involving the at least one signaling link has occurred.

5. The method of claim 1 wherein determining whether a transfer controlled message triggering condition exists for at least one signaling link in the telecommunications network comprises determining whether congestion exists on the least one signaling link.

6. The method of claim 1 wherein suppressing generation of transfer controlled messages for a predetermined time period comprises:
(a) starting a timer;
(b) determining whether the timer has expired; and
(c) in response to determining that the timer has not expired, suppressing generation of transfer control messages.

7. The method of claim 1 comprising, during the predetermined time period, ceasing to suppress generation of transfer controlled messages in response to detecting a predetermined number of unacknowledged messages transmitted over the at least one signaling link.

8. The method of claim 7 wherein ceasing to suppress generation of transfer controlled messages comprises:
(a) determining the number of messages transmitted by the SS7 network node to a remote endpoint over the least one signaling link that have not been acknowledged by the remote endpoint;
(b) comparing the number of unacknowledged transmitted messages to a threshold value; and
(c) generating a transfer controlled message when the number of unacknowledged transmitted messages exceeds the threshold value.

9. The method of claim 8 wherein determining the number of messages transmitted by the SS7 network node to a remote endpoint over the at least one signaling link that have not been acknowledged by the remote endpoint comprises determining a number of messages stored in a retransmit buffer of the SS7 network node, the retransmit buffer being associated with the at least one signaling link.

10. A method for suppressing congestion control, the method comprising:
at an SS7 network node:
(a) determining whether a transfer controlled (TFC) message triggering condition exists for at least one signaling link in a telecommunications network; and
(b) in response to determining that a transfer controlled message triggering condition exists, suppressing generation of a transfer controlled message based on a number of unacknowledged messages associated with the least one signaling link.

11. The method of claim 10 wherein suppressing generation of a transfer control message based on a number of unacknowledged messages associated with the at least one signaling link comprises:
(a) determining the number of-messages transmitted by the SS7 network node to a remote endpoint that have not been acknowledged by the remote endpoint;
(b) comparing the number of unacknowledged transmitted messages to a threshold value; and
(c) generating a transfer controlled message when the number of unacknowledged transmitted messages exceeds the threshold value.

12. The method of claim 11 wherein determining the number of messages transmitted to a remote endpoint over the least one signaling link that have not been acknowledged by the remote endpoint comprises determining a number of messages stored in a retransmit buffer of the SS7 network node, the retransmit buffer being associated with the at least one signaling link.

13. A system for suppressing congestion control comprising:
at an SS7 network node:
(a) logic configured to determine whether a transfer controlled (TFC) message triggering condition exists for at least one signaling link in a telecommunications network; and
(b) logic configured to, in response to determining that a transfer controlled message triggering condition exists, suppress generation of transfer controlled messages for a predetermined time period.

14. The system of claim 13 wherein the SS7 network node comprises a signaling transfer point (STP).

15. The system of claim 13 wherein the logic configured to determine whether a transfer controlled message triggering condition exists for at least one signaling link in the telecommunications network determines that a changeover procedure involving the at least one signaling link has occurred.

16. The system of claim 13 wherein the logic configured to determine whether a transfer controlled message triggering condition exists for at least one signaling link in the telecommunications network determines that a changeback procedure involving the at least one signaling link has occurred.

17. The system of claim 13 wherein the logic configured to determine whether a transfer controlled message triggering condition exists for at least one signaling link in the telecommunications network determines whether there is congestion on the least one signaling link.

18. The system of claim 13 wherein the logic configured to suppress generation of transfer controlled messages for a predetermined time period:
(a) starts a timer;
(b) determines whether the timer has expired; and
(c) in response to determining that the timer has not expired, suppresses generation of transfer control messages.

19. The system of claim 13, further comprising logic configured to cease to suppress the generation of transfer controlled messages in response to detecting the predetermined number of unacknowledged messages that were transmitted by the SS7 network node over the least one signaling link.

20. The system of claim 19 wherein the logic configured to cease to suppress the generation of transfer controlled messages comprises:
(a) logic configured to determine the number of messages transmitted by the SS7 network node to a remote endpoint over the least one signaling link that have not been acknowledged by the remote endpoint;
(b) logic configured to compare the number of unacknowledged transmitted messages to a threshold value; and
(c) logic configured to generate a transfer controlled message when the number of unacknowledged transmitted messages exceeds the threshold value.

21. The system of claim 20 wherein the logic configured to determine the number of messages transmitted by the SS7 network node to a remote endpoint over the at least one signaling link that have not been acknowledged by the remote endpoint determines a number of messages stored in a retransmit buffer of the SS7 network node, the retransmit buffer being associated with the at least one signaling link.

22. A system for suppressing congestion control comprising:
at an SS7 network node
(a) logic configured to determine whether a transfer controlled (TFC) message triggering condition exists for at least one signaling link in a telecommunications network; and
(b) logic configured to, in response to determining that a transfer controlled message triggering condition exists, suppress generation of a transfer controlled message based on a number of unacknowledged messages associated with the least one signaling link.

23. The system of claim 22 wherein the logic configured to suppress generation of a transfer control message based on a number of unacknowledged messages associated with the at least one signaling link comprises:
(a) logic configured to determine the number of messages transmitted by the SS7 network node to a remote endpoint that have not been acknowledged by the remote endpoint;
(b) logic configured to compare the number of unacknowledged transmitted messages to a threshold value; and
(c) logic configured to generate a transfer controlled message when the number of unacknowledged transmitted messages exceeds the threshold value.

24. The system of claim 23 wherein the logic configured to determine the number of messages transmitted by the SS7 network node to a remote endpoint that have not been acknowledged by the remote endpoint determines a number of messages stored in a retransmit buffer of the SS7 network node, the retransmit buffer being associated with the at least one signaling link.

25. A system for suppressing SS7 congestion control at an SS7 network node, the system comprising:
(a) a timer for defining a time period for suppressing generation of transfer controlled (TFC) messages; and
(b) a TFC suppressor for detecting whether a TFC generating condition exists, and, in response, for suppressing generation of TFC messages during the time period specified by the timer.

26. A system for suppressing congestion control in a telecommunications signaling network, the system comprising:
(a) a congestion controller for determining whether a TFC triggering condition exists on an SS7 signaling link, and, in response, for generating a TFC message; and
(b) a TFC suppressor, for detecting whether the TFC triggering condition matches a predetermined TFC triggering condition, and, in response, for suppressing generation of the TFC message.

27. A computer program product comprising computer executable instructions embodied in a computer-readable medium for performing steps comprising:
at an SS7 network node:
(a) determining whether a transfer controlled (TFC) message triggering condition exists for at least one signaling link; and
(b) in response to determining that a transfer controlled message triggering condition exists, suppressing generation of transfer controlled messages for a predetermined time period.

28. A computer program product comprising computer executable instructions embodied in a computer-readable medium for performing steps at a signaling system 7 (SS7) network node in a telecommunications network, the steps comprising:
at an SS7 network node:
(a) determining whether a transfer controlled (TFC) message triggering condition exists for at least one signaling link; and
(b) in response to determining that a transfer controlled message triggering condition exists, suppressing generation of a transfer controlled message based on a number of unacknowledged messages associated with the least one signaling link.
